(19) United States
(12) Patent Application Publication
(10) Pub. No.: US 2011/0298258 A1
(43) Pub. Date: Dec. 8, 2011

(54) INFANT VEHICLE SEAT CARRIAGE

(76) Inventor: Robert Anthony Davies, Cardiff (GB)

(21) Appl. No.: 13/139,348

(22) PCT Filed: Dec. 11, 2009
(86) PCT No.: PCT/GB09/02875

§ 371 Date: Aug. 28, 2011

(30) Foreign Application Priority Data
Dec. 11, 2008 (GB) 0822581.5

(51) Int. Cl. B60N 2/28; B62B 1/00

(52) U.S. Cl. 297/256.16; 280/658

(57) ABSTRACT

An infant vehicle seat carriage is disclosed. The carriage comprises a base for supporting an infant vehicle seat, a frame which extends from the base and a handle disposed upon the frame. The carriage further comprises coupling means which is arranged to couple the seat to the carriage. The frame is reconfigurable between an operative configuration in which the carriage permits the infant vehicle seat to be manoeuvred and a storage configuration in which the infant vehicle seat is securable within a vehicle while the carriage is coupled to the infant vehicle seat.

The present invention relates to an infant vehicle seat carriage.

Vehicle seats for infants are either arranged to be permanently fixed within a vehicle or detachably coupled within a vehicle. The detachable variety are typically reserved for babies, and comprise a stroller frame which enables the seat to be coupled directly therewith without having to disturb the baby within the seat. The parent or guardian can then transport the seat and thus the baby by manoeuvring the frame. However, the stroller frames are typically bulky and therefore occupy significant space within a vehicle. In addition, the frame is often time consuming to retrieve from the vehicle and erect.

Accordingly, it is common for the parent or guardian to carry the seat when the time taken to transfer the seat from the vehicle to the venue and back again is comparable with the time to retrieve and erect the frame. In these circumstances, it is common for the parent or guardian to become fatigued, which increases the risk of the parent or guardian dropping the seat and thus the baby.

I have now devised an infant vehicle seat carriage which alleviates the above-mentioned problems.

In accordance with the present invention there is provided an infant vehicle seat carriage, the carriage comprising a base for supporting an infant vehicle seat, a frame which extends from the base and a handle disposed upon the frame, the carriage further comprising coupling means which is arranged to couple the seat to the carriage,
wherein the frame is reconfigurable between an operative configuration in which the carriage permits the infant vehicle seat to be manoeuvred and a storage configuration in which the infant vehicle seat is securable within a vehicle while the carriage is coupled to the infant vehicle seat.

The carriage of the present invention thus enables the infant vehicle seat to be coupled and uncoupled from a car seat for example, without having to remove the infant seat from the carriage. A parent or guardian can thus simply remove the infant seat and carriage and reconfigure the frame to facilitate manoeuvring of the seat without having to first retrieve a bulky stroller frame for example, and subsequently erect the frame.

The frame is preferably reconfigurable between at least two operative configurations and a storage configuration. Preferably, the frame is retractably extendable such that the at least two operative configurations comprise at least two extended configurations of the frame and the storage configuration comprises a retracted configuration of the frame.

The frame preferably comprises first and second members which are separately coupled at a proximal end thereof to the base and at a distal end thereof to the handle. The first and second members preferably comprise telescopic members.

The frame is preferably arranged to extend along a rear of the infant vehicle seat and the base is preferably arranged to extend at least partially along an underside of the infant vehicle seat.

The handle preferably comprises an actuator for releasably locking the frame in the or each operative configuration and the storage configuration. The actuator preferably comprises a button disposed upon the handle.

Preferably, the coupling means comprises a clamp which is disposed upon the frame. The clamp is preferably arranged to extend over an upper region of the infant seat to clamp the seat to the base. Preferably, the clamp is arranged to slide upon the frame and is lockable upon the frame to effect coupling and uncoupling of the seat to the carriage.

Preferably, the clamp is retractably extendable in a direction substantially perpendicular to the frame to accommodate different size infant vehicle seats.

The coupling means preferably further comprises at least one strap for further coupling the infant vehicle seat to the carriage.

The carriage preferably further comprises a wheel assembly disposed at the underside of the base to facilitate the manoeuvring of the carriage and thus the infant vehicle seat.

Preferably, the wheel assembly is detachably coupled to the base. Alternatively, or in addition thereto, the wheel assembly is preferably reconfigurable between a first configuration in which the wheels of the assembly extend substantially below the base and a second configuration in which the wheels of the assembly extend substantially within the base. This enables the wheels to be readily coupled and uncoupled from the base, and/or repositioned with respect to the base, to avoid the wheels contacting a vehicle seat, for example.

In accordance with the present invention as seen from a second aspect, there is provided an infant vehicle seat, the seat comprising an infant vehicle seat carriage of the first aspect.

Preferably, the carriage is formed integrally with the infant vehicle seat.

Further preferred features of the infant vehicle seat may comprise one or more of the preferred features of the infant vehicle seat carriage of the first aspect.

An embodiment of the present invention will now be described by way of example only and with reference to the accompanying drawings, in which:

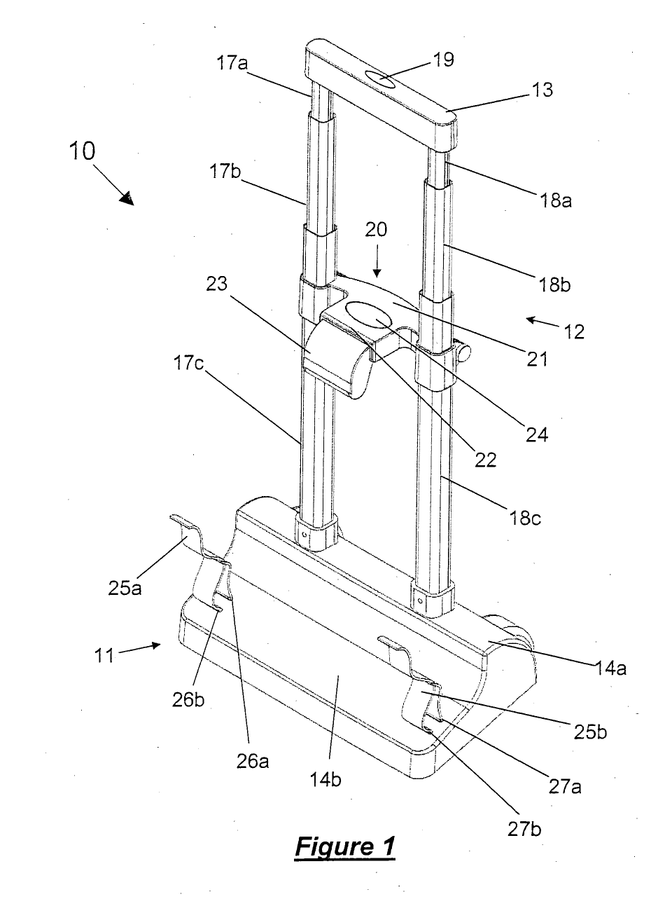

FIG. 1 is perspective view of the infant vehicle seat carriage according to an embodiment of the present invention, as viewed from above;

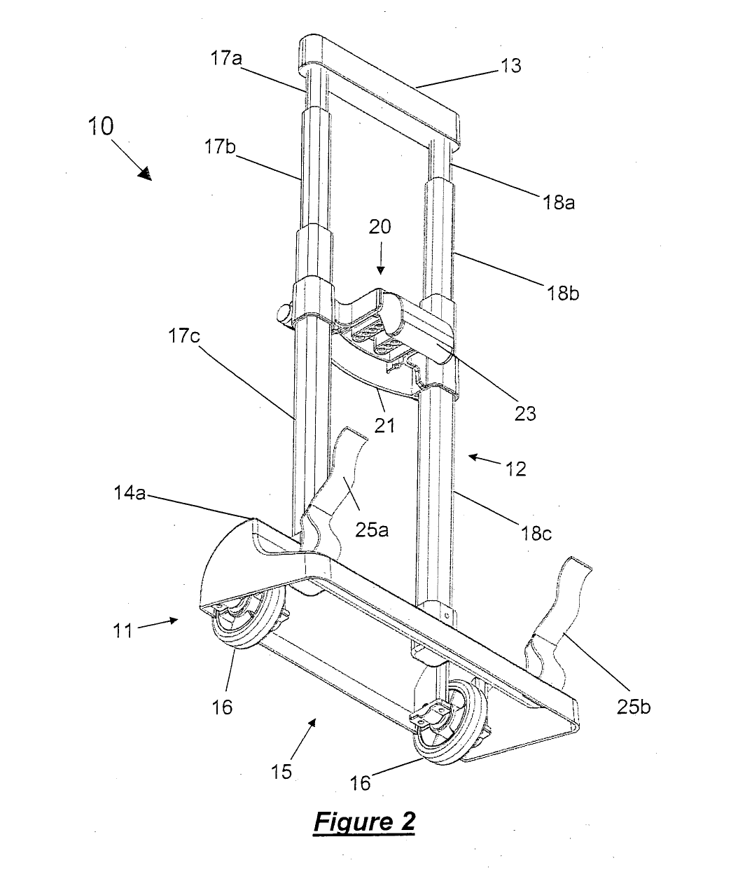

FIG. 2 is perspective view of the infant vehicle seat carriage according to an embodiment of the present invention, as viewed from below;

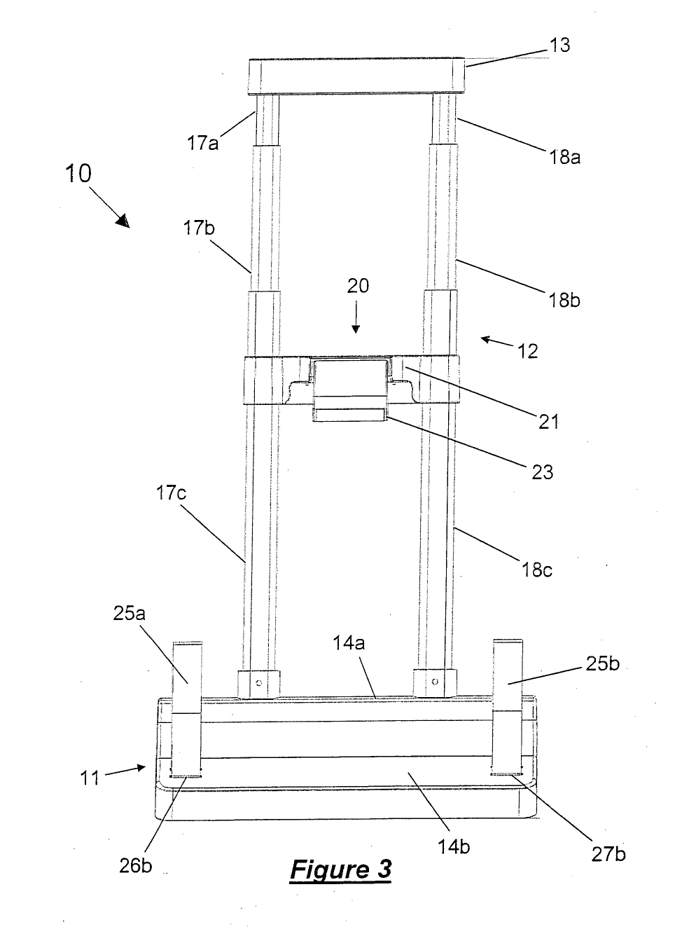

FIG. 3 is a front view of the infant vehicle seat carriage of FIG. 1 or 2; and,

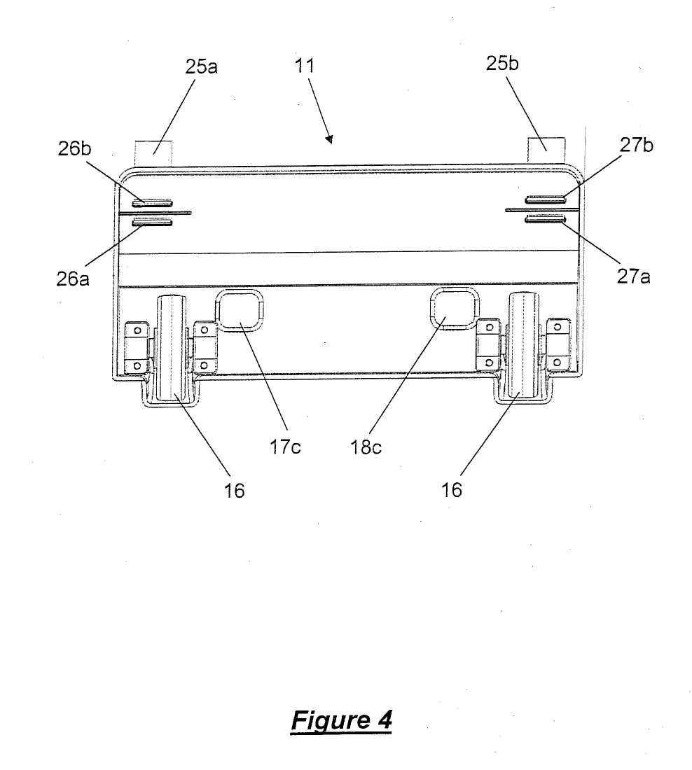

FIG. 4 is view of the underside of the base of the infant vehicle seat carriage of FIG. 1 or 2.

Referring to the FIGS. 1 to 3 drawings there is illustrated an infant vehicle seat carriage 10 according to an embodiment of the present invention. The carriage 10 may be formed of a rigid plastic material and comprises a base 11, a frame 12 which extends from the base and a handle 13 disposed upon the frame 12 for manipulating and manoeuvring the carriage 10 and thus an infant vehicle seat (not shown), such as an infant car seat.

The base 11 comprises a housing 14 which extends across a width of the carriage 10 and comprises an upper surface which is contoured to receive a portion of a base of an infant vehicle seat (not shown). The upper surface comprises a head portion 14a and a face portion 14b which extends forwardly of the head portion 14a and which slopes downwardly away from the head portion 14a toward a front of the base.

The underside of the base 11 is open and comprises a wheel assembly 15 formed therein, as illustrated in FIG. 4 of the drawings. The wheel assembly 15 comprises a wheel 16 disposed at each lateral side of the base 11. The wheels 16 are detachably coupled to the underside of the base 11, using a quick release finger operated screw (not shown), so that they can be removed if necessary, and the assembly 15 further comprises a mechanism (not shown) which permits the wheels 16 of the assembly 15 to be repositioned with respect to the base 11. The mechanism (not shown) enables the wheels 16 to be positioned in a first position so that they extend below the underside of the base 11 and a second position in which the wheels 16 extend substantially within the housing 14 of the base 11.

The frame 12 of the carriage 10 comprises a first and second telescopic member 17, 18, which extend from the head portion 14a of the base 11 at opposite lateral sides thereof. Each member 17, 18 comprises three sections 17a-c, 18a-c which are telescopically arranged to enable the members 17, 18 and thus the frame 12 to be extended and retracted with respect to the base 11. The frame 12 further comprises a handle 13 disposed at an upper, distal end of the frame 13, which extends between the first and second member 17, 18. The handle 13 comprises a button 19 disposed substantially centrally thereof, such that upon pressing the button 19, the sections 17a-c, 18a-c of the members 17, 18 become unlocked and free to move to effect a reconfiguration of the frame 12. Upon releasing the button 19, the sections 17a-c, 18a-c are arranged to become locked to lock the frame 12 in a particular configuration.

The frame 12 further comprises a clamp 20 disposed thereon, intermediate the base 11 and the handle 13. The clamp 20 comprises a support 21 which extends between the first and second member 17, 18 and further comprises a clamping arm 22 which is rigidly coupled to the support 21 at a proximal end and which is downwardly turned at the distal end to form a hook 23. The support 21 is arranged to slide upon the first and second members 17, 18 to reposition the clamp 20 at various distances from the base 11. The support 21 comprises a button 24, similar to the button 19 on the handle 13, which is arranged to release the support 21 upon the first and second members 17, 18 when pressed, and which is arranged to lock the support 21 to the first and second members 17, 18 when released. The button 24 further enables the length of the clamping arm 22 to be adjusted, when the button 24 is pressed, to effect the separation of the downwardly turned distal end 23 of the clamping arm 22 from the frame 12, to accommodate different size infant vehicle seats (not shown). Upon releasing the button 24, the length of the clamping arm 22 becomes fixed.

The carriage 10 further comprises a strap 25a, 25b disposed at each lateral side of the base 11 which separately extend through a first and second slot 26a, 26b, 27a, 27b disposed at within the face portion, at each lateral side thereof. The free ends of each strap 25a, 25b comprise a hook-and-loop or VELCRO® type fastening arrangement (not shown) for further securing the infant vehicle seat (not shown) to the carriage 10.

In use, a user (not shown) couples the wheel assembly 15 to the underside of the base 11 or repositions the wheels 16 of the assembly 15 so that they extend below the underside of the base 11. A rear portion of a base of an infant vehicle seat (not shown) is then positioned upon the face portion 14b of the base 11 so that the frame members 17, 18 extend along a rear of the infant vehicle seat (not shown). The user (not shown) then pushes the button 24 on the support 21 to move the clamp 20, and in particular the clamping arm 22 into abutment with an upper region of the infant seat (not shown) and adjusts the length of the clamping arm 22 so that the hooked end 23 extends in close proximity with the upper region of the infant seat (not shown). The button 24 is then released to lock the clamp 20 upon the frame 12 and thus hold the seat (not shown) upon the base 11.

The straps 25a, 25b disposed at each side of the carriage base 11 are then separately looped around a handle (not shown) of the infant seat, for example, and the free ends of each strap are separately secured using the VELCRO® fastening arrangement (not shown) to further secure the infant seat (not shown) to the carriage 10. A user (not shown) then pushes the button 19 on the handle 13, reconfigures the length of the frame 12 to a suitable height and subsequently releases the button 19 to lock the frame 12 in an extended configuration which is suitable for manoeuvring the carriage 10 and thus the infant vehicle seat (not shown).

Once the carriage 10 has been secured to the infant seat (not shown), the frame 12 can be retracted to the storage configuration and the wheel assembly 15 manipulated to remove the wheels 16 or reposition the wheels 16 within the base 11. The infant seat (not shown) can then be secured within a vehicle (not shown) in the normal manner with the carriage 10 secured thereto. The repositioning of the wheels 16 minimises any dirt or debris thereon becoming transferred to the vehicle seat (not shown). When it becomes necessary to remove the infant seat (not shown), a user (not shown) simply removes the seat in the normal manner, repositions the wheels 16 of the carriage 10 and pulls the handle 13 while pushing the handle button 19 to reconfigure the frame 12 to an operative configuration. The carriage 10 according to the embodiment of the present invention can thus remain secured to an infant vehicle seat (not shown) so that it is readily available for use upon removing the infant vehicle seat (not shown) from the vehicle (not shown). Accordingly, it is envisaged that the carriage 10 of the present invention may be made and integral feature of an infant vehicle seat (not shown).

From the foregoing therefore, it is evident that the carriage provides a simple yet effective means of readily transporting an infant in a vehicle seat.

1. An infant vehicle seat carriage, the carriage comprising a base for supporting an infant vehicle seat, a frame which extends from the base and a handle disposed upon the frame, the carriage further comprising coupling means which is arranged to releasably couple the seat to the carriage,
wherein the frame is reconfigurable between an operative configuration in which the carriage permits the infant vehicle seat to be manoeuvred and a storage configuration in which the infant vehicle seat is securable within a vehicle while the carriage is coupled to the infant vehicle seat.

2. A carriage according to claim 1, wherein the frame is reconfigurable between at least two operative configurations and a storage configuration.

3. A carriage according to claim 2, wherein the frame is retractably extendable such that the at least two operative configurations comprise at least two extended configurations of the frame and the storage configuration comprises a retracted configuration of the frame.

4. A carriage according to claim 1, wherein the frame comprises first and second members which are separately coupled at a proximal end thereof to the base and at a distal end thereof to the handle.

5. A carriage according to claim 4, wherein the first and second members comprise telescopic members.

6. A carriage according to any preceding claim 1, wherein the frame is arranged to extend along a rear of the infant vehicle seat and the base is arranged to extend at least partially along an underside of the infant vehicle seat.

7. A carriage according to claim 1, wherein the handle comprises an actuator for releasably locking the frame in the or each operative configuration and the storage configuration.

8. A carriage according to claim 7, wherein the actuator comprises a button disposed upon the handle.

9. A carriage according to claim 1, wherein the coupling means comprises a clamp which is disposed upon the frame.

10. A carriage according to claim 9, wherein the clamp is arranged to extend over an upper region of the infant seat to clamp the seat to the base.

11. A carriage according to claim 9, wherein the clamp is arranged to slide upon the frame and is lockable upon the frame to effect coupling and uncoupling of the seat to the carriage.

12. A carriage according to claim 9, wherein the clamp is retractably extendable in a direction substantially perpendicular to the frame to accommodate different size infant vehicle seats.

13. A carriage according to claim 9, wherein the coupling means further comprises at least one strap for further coupling the infant vehicle seat to the carriage.

14. A carriage according to claim 9, further comprising a wheel assembly disposed at the underside of the base to facilitate the manoeuvring of the carriage and thus the infant vehicle seat.

15. A carriage according to claim 14, wherein the wheel assembly is detachably coupled to the base.

16. A carriage according to claim 14, wherein the wheel assembly is reconfigurable between a first configuration in which the wheels of the assembly extend substantially below the base and a second configuration in which the wheels of the assembly extend substantially within the base.

17. An infant vehicle seat, the seat comprising an infant vehicle seat carriage according to claim 1.

18. An infant vehicle seat carriage, the carriage comprising a base for supporting an infant vehicle seat, a frame which extends from the base and a handle disposed upon the frame, the carriage further comprising a clamp which is arranged to releasably couple the seat to the carriage,
wherein the frame is reconfigurable between an operative configuration in which the carriage permits the infant vehicle seat to be manoeuvred and a storage configuration in which the infant vehicle seat is securable within a vehicle while the carriage is coupled to the infant vehicle seat
